(19) United States
(12) Patent Application Publication
(10) Pub. No.: US 2012/0317171 A1
(43) Pub. Date: Dec. 13, 2012

(54) System and Method for Sharing Web Contents for Building Rich Internet Applications

(76) Inventor: Chi-Hung LU, Gaithersburg, MD (US)

(21) Appl. No.: 13/155,954

(22) Filed: Jun. 8, 2011

(51) Int. Cl. G06F 15/16

(52) U.S. Cl. 709/203

(57) ABSTRACT

An Internet-based system and application includes both a server and a plurality of client hardware platforms for executing the server as well as the client software. The current invention provides both bottom-up and top-down approaches in modeling information while all other existing systems provide only bottom-up approach. The system and application provide a set of pre-build widgets, also called “molecules”, that spare users from the details and complexity of the underlying web technologies while allowing them to build end applications from intermediary components called droplets by simply assembling and connecting existing molecules. Droplets are stored in a centralized repository wherein all other droplets that have been previously created by this user or others are also stored. Droplets can be selectively shared with others by assigning read/write privileges on creation or on the fly. Multiple droplets can be saved as a single HTML file called a formation. Multiple formations arranged in a pre-determined sequential order typical of a presentation can be packaged as an application. Molecules, droplets, formations, and applications are all sharable units within the system.

### FIELD OF INVENTION

This invention relates to resources sharing on the Internet by re-using already built Web components to assemble new Web applications.

### BACKGROUND OF THE INVENTION

A typical method of building a Web application is by using local resources from the user's computer. For example, U.S. Pat. Nos. 6,938,205 and 7,316,003 describe object-oriented visual editors to create monolithic desktop applications. These prior arts do not allow smaller building blocks of a web document, usually called “widgets”, to be shared and reused in remote documents nor do they provide the flexibility to encapsulate existing web contents into reusable and sharable components.

The current invention is a novel approach for enabling team collaborations on web applications. Instead of sharing text-based HTML, JavaScript, XML, and CSS files, the system allows users to model information as autonomous objects for performing specific tasks. These objects are deposited in a central repository and can be shared and combined with objects from other users to build new applications. The componentization of web that is normally declarative and sequential in nature makes creating and collaborating on any complex web application a relatively easy task.

### SUMMARY OF THE INVENTION

The current invention provides both bottom-up and top-down approaches in modeling information while all other existing systems provide only bottom-up approach. The current invention provides a set of pre-build widgets, also called “molecules”, that spare users from the details and complexity of the underlying web technologies while allowing them to build end applications and intermediary components called droplets by simply assembling and connecting existing molecules. The resulting droplets are stored in a centralized repository wherein all other droplets that have been previously created by this user or others are also stored. Droplets can be selectively shared with others by assigning read/write privileges on creation.

From the top-down approach, the current invention allows users to combine semantically related information into one sharable unit, a droplet. The droplet is technically an HTML container for molecules. A droplet's behavior is programmed by the enclosed molecules. It can be cloned dynamically and its behavior inherited and modified. The combined top-down and bottom-up approach gives users the ultimate flexibility to model any information as autonomous semantic objects sharable with other users for building end applications.

The current invention provides a user interface for programming software components, the droplets, and web applications. The authoring process involves drag-and-dropping molecules into droplets in a working area, called condenser, and to link droplets using messages. Droplets can be deposited into a central repository on the system. Other users, with a sharing privileges designated by the author of the droplets, can reuse these droplets to create his/her own applications.

### BRIEF DESCRIPTION OF THE DRAWINGS

FIG. 1 is a display of the client system and software showing general features.

FIG. 2 is a display of the system and software showing the mash-up of dynamic contents from multiple WEB sites.

FIG. 3 is a display of the system and software showing the cloning.

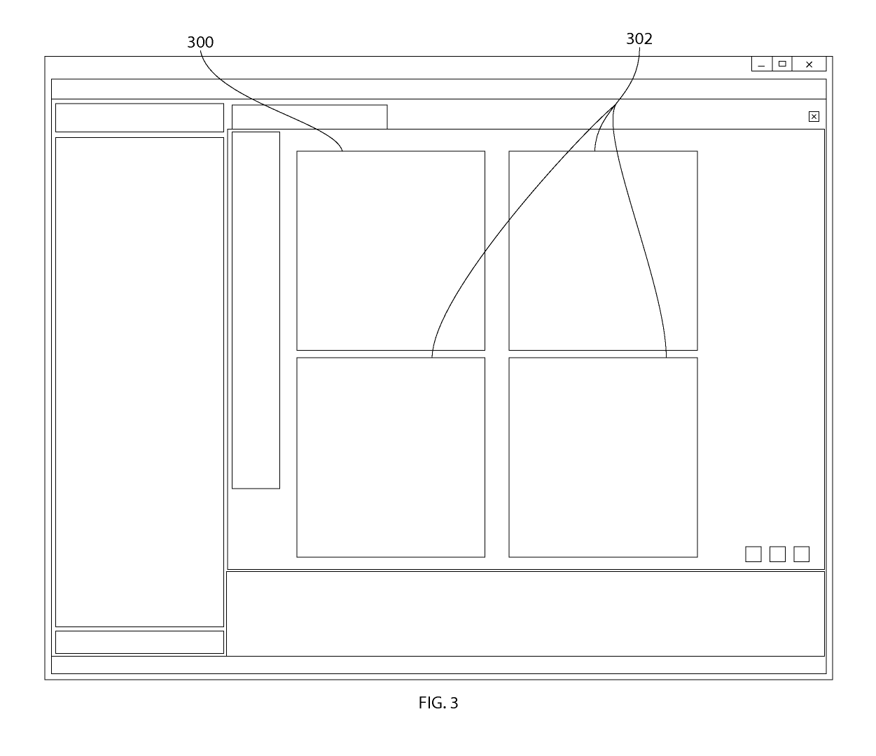

FIG. 4 is a display of the system and software showing the preference dialog.

FIG. 5 is a display of the system and software showing the embedded WEB browser.

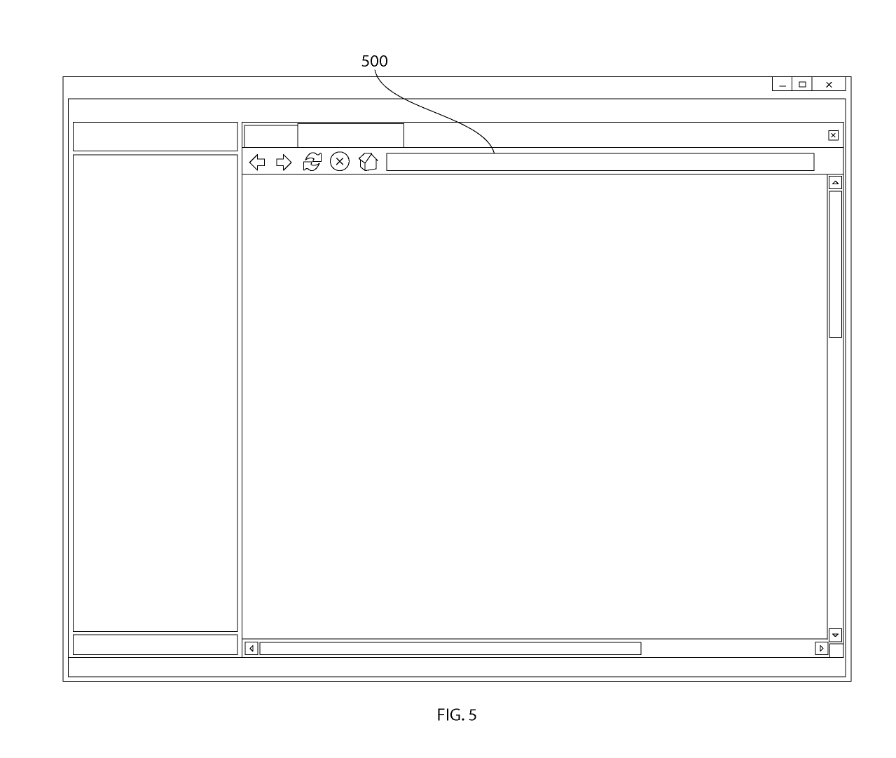

FIG. 6 is a display of the system and software showing packaging multiple mashed files into a WEB application.

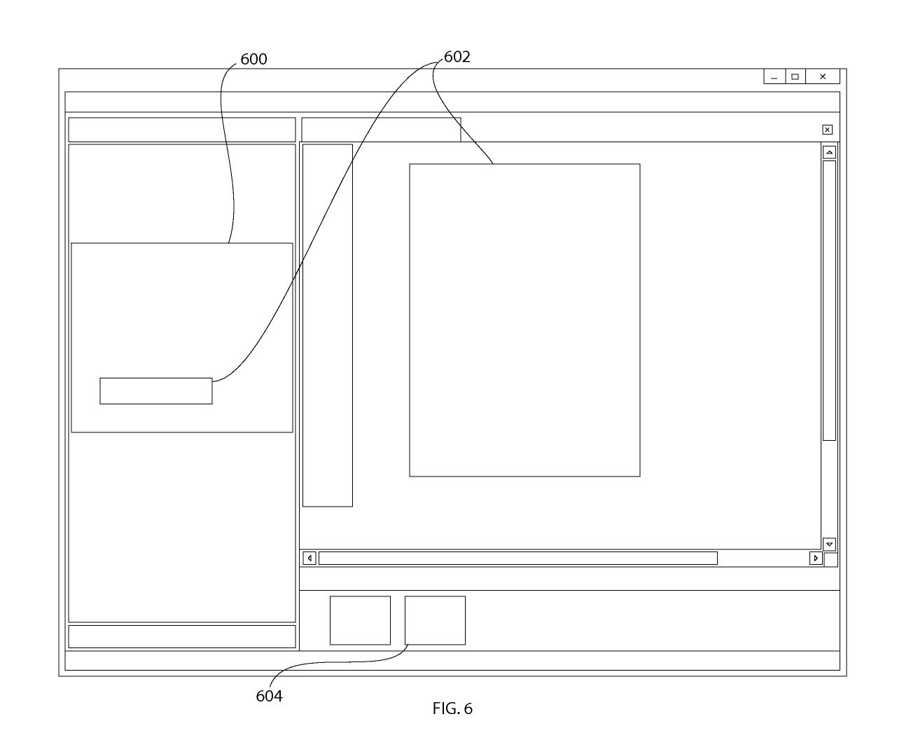

### DETAIL DESCRIPTIONS OF THE INVENTION

The current invention is an Internet-based system and application which includes both a server and a plurality of client hardware platforms for executing the server as well as the client software. The server hardware platform is a computer processor with all essential accessories including data storage medium, a monitor, and a keyboard etc. which are configured subject to the processing load requirements. The client hardware platform is a computer processor with all essential accessories including data storage medium, a monitor, and a keyboard, etc. which is configured subject to the processing load requirements. The plurality of clients communicate with the server via the Internet.

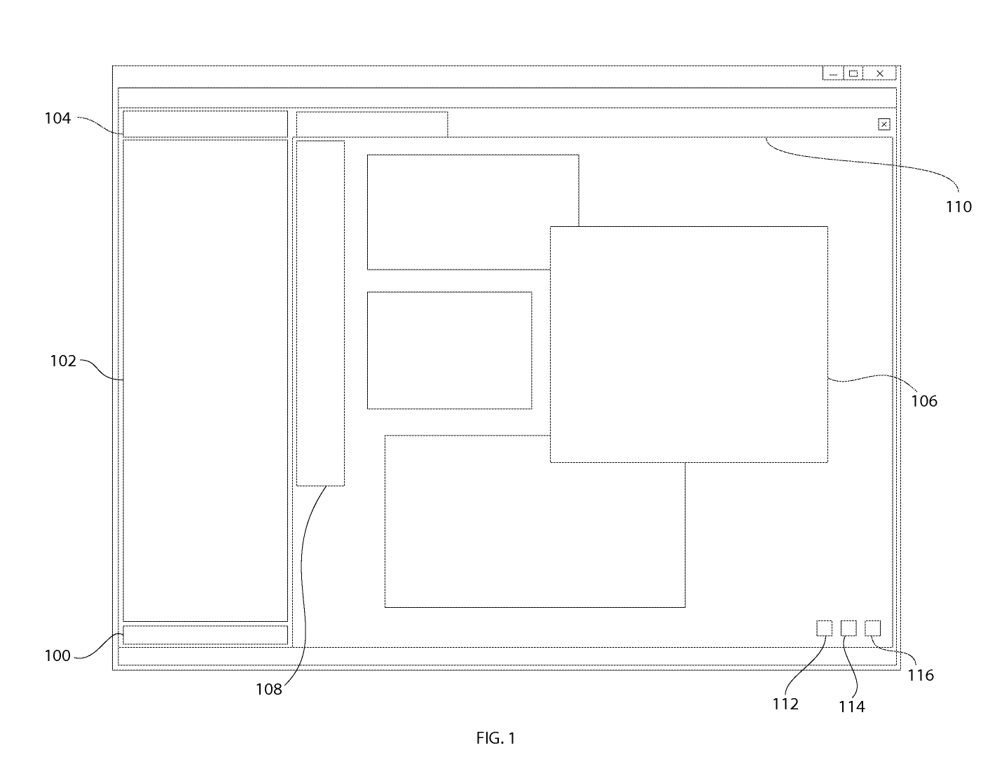

The server provides the majority of the system functions of the current invention that a user access from any of the remote clients. The FIG. 1 is a full view of the client software after being launched by a user in a desktop window and logged into the user's account. The interface is comprised of a file/folder navigation panel to the left and a tabbed browser space to the right. The browser space allows for launching helper applications into different tabs. The build-in helper applications include the Condenser, a file search utility, an Access Control Manager, and an embedded web browser. These helper applications can also be launched from the menu bar near the top of the window. The FIG. 1 shows the Condenser opened in the first tab. The file/folder navigation panel provides the direct access to the stored files either as an independent file or groups of related files organized in a folder. The files and folder are physically created on the server under the user's account. Droplets authored by the user are examples of such files.

The navigation panel 100, 102, 104 allows users to remotely manage files and folders located in the server's database. As shown, the file/folder space 102 is vertically divided into two sections. On the top is the “shared” section where shared files and folders reside. At the bottom is the “private” section where users store their personal files and folders. To add a file, users can simply drag a file from the desktop or from the window explorer and drop it into the private section. The file is instantly encrypted and transferred to the server and placed into a secure database. To share a file with read-only access, users can simply drag the file from the private section and drop it into any one of the shared folders in the shared section.

Along the top of the file/folder space is the navigation bar 104. It shows the path of a selected item relative to the root of the file system on the server. It also lets users navigate in and out of folders or refresh the list of the file/folder 102 from the server.

Along the bottom of the file/folder space is the shortcut bar 100. It allows users to show/hide shared sections and open/close all folders, etc.

The Condenser 106 comprises a factory dialog 108 and a workspace 110. From the factory dialog, users can create instances of droplet (the grey container) and molecules by dragging their respective icons to the workspace. When a molecule is added to a droplet, it adds to or modifies the existing appearance and behavior of the droplet. For instance, when an IFrame molecule is dropped into a droplet with its “URL” attribute set to “http://www.google.com”, the Google home page is loaded into that droplet.

Some molecules after being added to a droplet allow in-place editing. This includes the Text, Canvas, and Camera molecules. When double-click on the droplet containing any of these molecules, it enters into the edit mode for that molecule. For Text molecule, the droplet becomes an html:textarea for entering HTML text directly. For Canvas molecule, the droplet becomes a drawing board for editing 2D graphics. For Camera molecule, the droplet allows users to manipulate camera's position and view angles and 3D objects' placements and alignments. After editing, another double-click on the droplet will switch from edit mode back to display mode.

The Google Map molecule embeds Google Map into droplets. Google Map's internal events are elevated to the document level and become detectable by other droplets. This makes possible highly interactive map applications. Google's GeoCoder is also included in the molecule allowing users to mark any address on the map.

In order to access other third party web services, the AJAX molecule and the XML molecule can be used in combination to post HTTP requests and retrieve and parse returned XML data. The Server and Client molecules create server and client sockets and can be used in creating peer-to-peer type of applications.

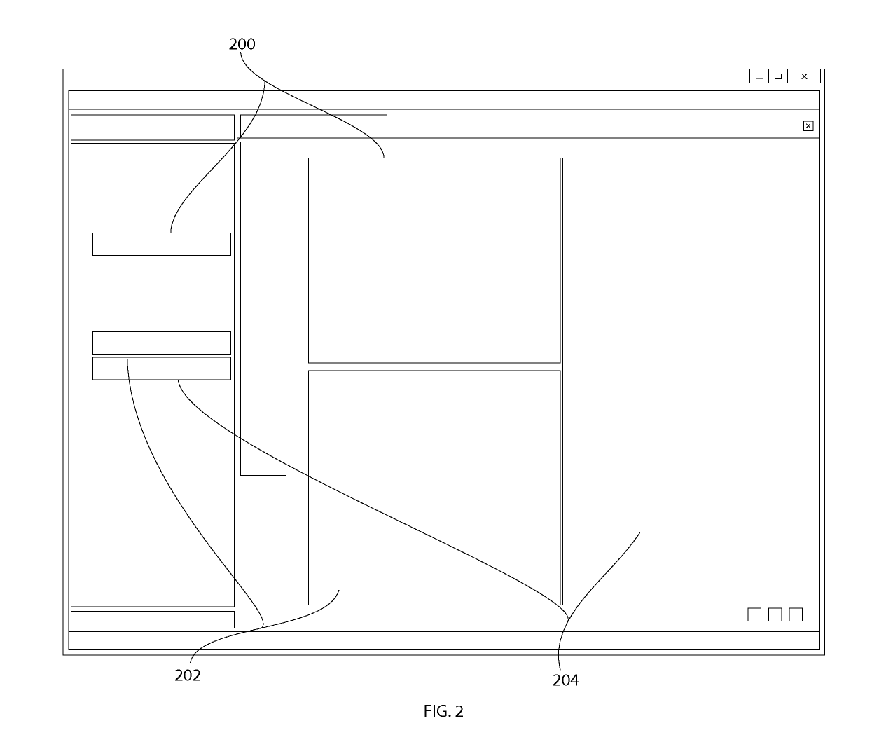

The FIG. 2 shows a scenario where contents from three different web sites are mashed up in one document. The procedure to mash up web contents is by dragging the web site proxy icon located in the far left of the address bar of the embedded web browser 500 and drop it into the private file space. A bookmark is instantly created. When a bookmark is drag-and-dropped into a droplet, an IFrame molecule is automatically created and its URL is loaded into the droplet.

Each droplet and molecule can be cloned dynamically in both edit and runtime modes. Users can simply press “Crtl” key and drag the original copy 300 to new locations to create clones 302. During runtime, clones can be created by invoking the clone function in a JavaScript.

The clone function is one of many member functions exposed by each droplet and molecule. Each molecule also exposes a set of attributes that can be modified via the preference dialog 400 during edit mode and scripted using JavaScript during runtime mode.

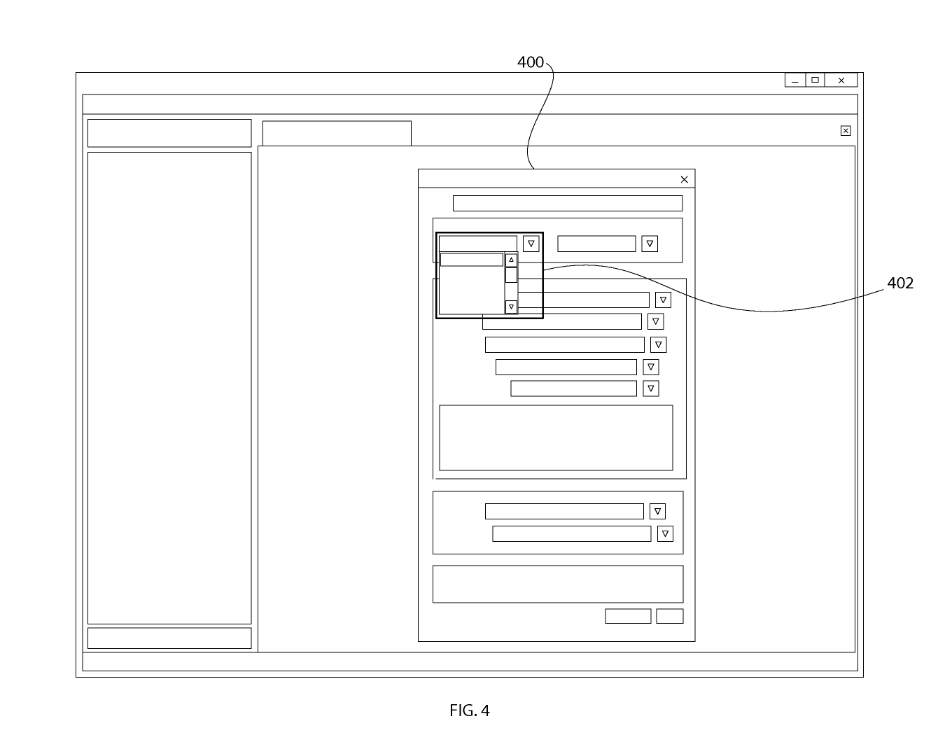

As seen in FIG. 4, each preference dialog often contains the “Enable When” 402 and “Disable When” drop down menus allowing users to select from a list of events such as click, mouseover, mouseout, mousedown, mouseup events to turn on and off the service provided by the molecule. The Event Receiver molecule allows custom events to be added to the drop down lists of other molecules within the same droplet.

A special kind of molecule called the “Alias molecule” takes a path to a Script molecule and assume its behavior, hence the name “alias”. Since its path attribute can be modified during runtime, it is possible to create a library of Script molecules and use Alias molecule to acquire different behavior for a droplet during runtime.

When a droplet is done with being programmed, it can be saved to the file space 102 by dragging the red box icon at the top right corner of the droplet and dropping it into the private file space. Reversely, a saved droplet file can be dragged and dropped into the workspace to recover the original droplet.

Near the bottom left corner of the workspace is a set of three buttons 112, 114, 116. Button 112 erases all droplets currently in workspace. Button 116 is the Edit/Preview mode for toggling and allowing users to see how the application works during the runtime. Button 114 serves two purposes. A click on the button brings up the document configuration dialog which allows user to rename document, include external JavaScripts, change document background, and adjust grid spacing. Dragging the same button and dropping it into the private file space saves the document as a special type of HTML file called a formation. Reversely, the document can be restored by drag-n-dropping the formation file back into the workspace of the Condenser.

A saved formation document and linked data files can be packaged together as a application 600. The process of making an application is simply to gather all relevant files into one folder including a default page called “index.html” 602, by right clicking on the folder, and select “Make App”. The target folder will change its icon to that of an application. An application, in essence, is a web site hosted by the server. Users or a group of users can share their presentations by simply drag-and-dropping the application folder to the shared section of the file space. With read-only access, a shared application appears as a single clickable icon and when clicked, it launches the web application in a new browser tab.

Applications can be dragged to the Application Manager 604 which acts as a quick launch bar. Within Application Manager, applications are categorized for easier access (see FIG. 7). Any application managed by the Application Manager can be dragged to the desktop and run as a standalone desktop application. This allows distraction-free browsing and the author of the application has full control of the audiences' attentions.

1. A method of sharing World Wide Web (WEB) contents for building rich Internet applications by executing computer-executable instructions stored on a non-transitory computer-readable medium comprises the steps of:
providing a server;
providing a plurality of clients;
the plurality of clients connect and communicate with the server via the Internet;
providing a file-folder navigation panel on each of the plurality of clients;
providing a shared panel in the file-folder navigation panel;
providing a private panel in the file-folder navigation panel;
providing a browser space on each of the plurality of clients; and
providing a plurality of helper applications by the browser space wherein the helper applications are selected from the group consisting of a condenser, a file search utility, an access control manager, and an embedded WEB browser.

2. The method of sharing World Wide Web (WEB) contents for building rich Internet applications by executing computer-executable instructions stored on a non-transitory computer-readable medium of claim 1 comprises the steps of:
providing the helper applications by shared applications from the plurality of clients;
each of the helper applications is activated in the browser space and a tab index is assigned to each of the helper applications after the activations;
providing a menu bar; and
each of the helper applications is activated in the menu bar and a tab index is assigned to each of the helper applications after the activations.

3. The method of sharing World Wide Web (WEB) contents for building rich Internet applications by executing computer-executable instructions stored on a non-transitory computer-readable medium of claim 1 comprises the steps of:
storing files on the server and assigning a read-privilege, a write-privilege, or both to the files; and
storing the files on the server by encrypting and transmitting the files from the navigation panel.

4. The method of sharing World Wide Web (WEB) contents for building rich Internet applications by executing computer-executable instructions stored on a nontransitory computer-readable medium of claim 2 comprises the steps of:
providing an S-list of file names in the shared panel wherein the S-list includes files having no write privileges;
providing a P-list of file names in the private panel wherein the P-list includes files having read privileges and write privileges;
accessing the files from the navigation panel on each of the plurality of clients;
accessing shared files via the shared panel on each of the plurality of clients;
accessing private files via the private panel on each of the plurality of clients; and
changing a privilege to a file by selecting a file name from the P-list and dropping the selected file name into the shared panel.

5. The method of sharing World Wide Web (WEB) contents for building rich Internet applications by executing computer-executable instructions stored on a nontransitory computer-readable medium of claim 4 comprises the steps of:
providing a navigation bar where a storage location path of a file is displayed;
providing a shortcut bar;
providing a show-hide icon display wherein the show-hide icon display, when being selected, displaying or hiding the shared panel; and
providing an open-close icon display wherein the open-close icon display, when being selected, opening or closing all P-list and S-list.

6. The method of sharing World Wide Web (WEB) contents for building rich Internet applications by executing computer-executable instructions stored on a nontransitory computer-readable medium of claim 1 comprises the steps of:
providing a condenser;
providing a factory dialog and a workspace in the condenser;
providing a plurality of droplet;
providing a plurality of molecule icon displays;
each of the plurality of molecule icon displays represents a data file to be added to a droplet;
selecting and dragging a molecule icon display into the droplet to merge the data file represented by the selected molecule icon display with the data file of the droplet;
double-clicking the droplet icon to activate an editor for editing files associated with a molecule that have been selected and dragged into the droplet; and
the editor is selected from the group consisting of an editor editing HTML text, a vector graphic, an editor for manipulating a camera functions.

7. The method of sharing World Wide Web (WEB) contents for building rich Internet applications by executing computer-executable instructions stored on a nontransitory computer-readable medium of claim 6 comprises the steps of:
providing a clone function to clone the merged data file;
the clone function is activated in the editor;
providing a preference dialog menu;
enabling or disabling a predetermined service provided by a molecule at a specified event;
providing an event receiver molecule to accept and add molecules for predetermined services;
providing an alias molecule and the alias molecule defines a predetermined index to a predetermined molecule; and
dynamically changing the index defined by the alias molecule to a second index to a second predefined molecule.

8. A method of sharing World Wide Web (WEB) contents for building rich Internet applications by executing computer-executable instructions stored on a nontransitory computer-readable medium comprises the steps of:
providing a server;
providing a plurality of clients;
the plurality of clients connect and communicate with the server via the Internet;
providing a file-folder navigation panel on each of the plurality of clients;
providing a shared panel in the file-folder navigation panel;
providing a private panel in the file-folder navigation panel;
providing a browser space on each of the plurality of clients;
providing an S-list of file names in the shared panel wherein the S-list includes files having no write privileges; and
providing a P-list of file names in the private panel wherein the P-list includes files having read privileges and write privileges.

9. The method of sharing World Wide Web (WEB) contents for building rich Internet applications by executing computer-executable instructions stored on a nontransitory computer-readable medium of claim 8 comprises the steps of:
storing files on the server and assigning a read-privilege, a write-privilege, or both to the files;
storing the files on the server by encrypting and transmitting the files from the navigation panel;
providing a plurality of helper applications by the browser space wherein the helper applications are selected from the group consisting of a condenser, a file search utility, an access control manager, and an embedded WEB browser; and
each of the helper applications is activated in the browser space and a tab index is assigned to each of the helper applications after the activations.

10. The method of sharing World Wide Web (WEB) contents for building rich Internet applications by executing computer-executable instructions stored on a nontransitory computer-readable medium of claim 9 comprises the steps of:
providing the helper applications by shared applications from the plurality of clients;
providing a menu bar;
each of the helper applications is activated in the menu bar and a tab index is assigned to each of the helper applications after the activations;
accessing the files from the navigation panel on each of the plurality of clients;
accessing shared files via the shared panel on each of the plurality of clients;
accessing private files via the private panel on each of the plurality of clients; and
changing a privilege to a file by selecting a file name from the P-list and dropping the selected file name into the shared panel.

11. The method of sharing World Wide Web (WEB) contents for building rich Internet applications by executing computer-executable instructions stored on a nontransitory computer-readable medium of claim 8 comprises the steps of:
providing a condenser;
providing a factory dialog and a workspace in the condenser;
providing a plurality of molecule icon displays;
each of the plurality of molecule icon displays represents a data file;
selecting and dragging a molecule icon display into the factory dialog to merge the data file represented by the selected molecule icon display with the data file of the factory dialog;
double-clicking the factory dialog to activate an editor for editing the files that have been selected and dragged into the factory dialog; and
the editor is selected from the group consisting of an editor editing a graphic file, an editor for manipulating a camera functions.

12. The method of sharing World Wide Web (WEB) contents for building rich Internet applications by executing computer-executable instructions stored on a nontransitory computer-readable medium of claim 11 comprises the steps of:
providing a plurality of droplet;
providing a navigation bar where a storage location path of a file is displayed;
providing a shortcut bar;
providing a show-hide icon display wherein the show-hide icon display, when being selected, displaying or hiding the shared panel; and
providing an open-close icon display wherein the open-close icon display, when being selected, opening or closing all P-list and S-list.

13. The method of sharing World Wide Web (WEB) contents for building rich Internet applications by executing computer-executable instructions stored on a nontransitory computer-readable medium of claim 10 comprises the steps of:
providing a clone function to clone the droplet.
Providing a clone function to clone a molecule.

14. The method of sharing World Wide Web (WEB) contents for building rich Internet applications by executing computer-executable instructions stored on a nontransitory computer-readable medium of claim 13 comprises the steps of:
providing a preference dialog menu.

15. The method of sharing World Wide Web (WEB) contents for building rich Internet applications by executing computer-executable instructions stored on a nontransitory computer-readable medium of claim 14 comprises the steps of:
enabling or disabling a predetermined service provided by a molecule at a specified event; and
providing an event receiver molecule to add custom events to enable/disable molecules providing predetermined services.

16. The method of sharing World Wide Web (WEB) contents for building rich Internet applications by executing computer-executable instructions stored on a nontransitory computer-readable medium of claim 15 comprises the steps of:
providing an alias molecule and the alias molecule defines a predetermined index to a predetermined molecule; and
dynamically changing the index defined by the alias molecule to a second index to a second predefined molecule.

17. A method of sharing World Wide Web (WEB) contents for building rich Internet applications by executing computer-executable instructions stored on a nontransitory computer-readable medium comprises the steps of:
providing a server;
providing a plurality of clients;
the plurality of clients connect and communicate with the server via the Internet;
providing a file-folder navigation panel on each of the plurality of clients;
providing a shared panel in the file-folder navigation panel;
providing a private panel in the file-folder navigation panel;
providing a browser space on each of the plurality of clients;
providing a condenser;
providing a factory dialog and a workspace in the condenser;
providing a plurality of molecule icon displays;
providing a clone function to clone a droplet;
providing a clone function to clone a molecule;
the clone function is activated in the editor;
storing files on the server and assigning a read-privilege, a write-privilege, or both to the files;
storing the files on the server by encrypting and transmitting the files from the navigation panel;
providing a preference dialog menu;
enabling or disabling a predetermined service provided by a molecule at a specified event;
providing an event receiver molecule to add custom events to enable/disable molecules providing predetermined services.
providing an alias molecule and the alias molecule defines a predetermined index to a predetermined molecule; and
dynamically changing the index defined by the alias molecule to a second index to a second predefined molecule.

18. The method of sharing World Wide Web (WEB) contents for building rich Internet applications by executing computer-executable instructions stored on a nontransitory computer-readable medium of claim 17 comprises the steps of:
providing a menu bar;
providing a plurality of helper applications by the browser space wherein the helper applications are selected from the group consisting of a condenser, a file search utility, an access control manager, and an embedded WEB browser;
providing the helper applications by shared applications from the plurality of clients;
each of the helper applications is activated in the menu bar and a tab index is assigned to each of the helper applications after the activations;
providing a shortcut bar;
providing a show-hide icon display wherein the show-hide icon display, when being selected, displaying or hiding the shared panel; and
providing an open-close icon display wherein the open-close icon display, when being selected, opening or closing all P-list and S-list.

19. The method of sharing World Wide Web (WEB) contents for building rich Internet applications by executing computer-executable instructions stored on a nontransitory computer-readable medium of claim 17 comprises the steps of:
each of the helper applications is activated in the browser space and a tab index is assigned to each of the helper applications after the activations;
providing an S-list of file names in the shared panel wherein the S-list includes files having no write privileges;
providing a P-list of file names in the public panel wherein the P-list includes files having read privileges and write privileges;
accessing the files from the navigation panel on each of the plurality of clients;
accessing shared files via the shared panel on each of the plurality of clients;
accessing private files via the private panel on each of the plurality of clients;
changing a privilege to a file by selecting a file name from the P-list and dropping the selected file name into the shared panel; and
providing a navigation bar where a storage location path of a file is displayed.

20. The method of sharing World Wide Web (WEB) contents for building rich Internet applications by executing computer-executable instructions stored on a nontransitory computer-readable medium of claim 18 comprises the steps of:
each of the plurality of molecule icon displays represents a data file;
selecting and dragging a molecule icon display into the droplet to merge the data file represented by the selected molecule icon display with the current data files of the droplet;
double-clicking the droplet icon to activate an editor for editing the data file associated with a molecule that have been selected and dragged into the droplet; and
the editor of the selected molecule including an editor editing HTML text, a vector graphic, an editor for manipulating a camera functions.
